(19) United States
(12) Patent Application Publication
(10) Pub. No.: US 2001/0003635 A1
(43) Pub. Date: Jun. 14, 2001

(54) Developer material and developing unit using the developer material

(76) Inventors: Takuya Goto, Tokyo (JP); Hiroaki Sato, Tokyo (JP)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 09/730,433

(22) Filed: Dec. 5, 2000

(30) Foreign Application Priority Data
Dec. 9, 1999 (JP) 350159/99

(51) Int. Cl. G03G 9/08

(52) U.S. Cl. 430/108.11; 430/108.3; 430/108.24

(57) ABSTRACT

A developing material is used for developing an electrostatic latent image in an electrophotographic process. The developing material includes a toner formed of a resin binder and a coloring material, and an oil added to surfaces of particles of the toner. The oil may be silicone oil or fluorine oil. The oil is in the range of 0.01-3.0 wt. %.

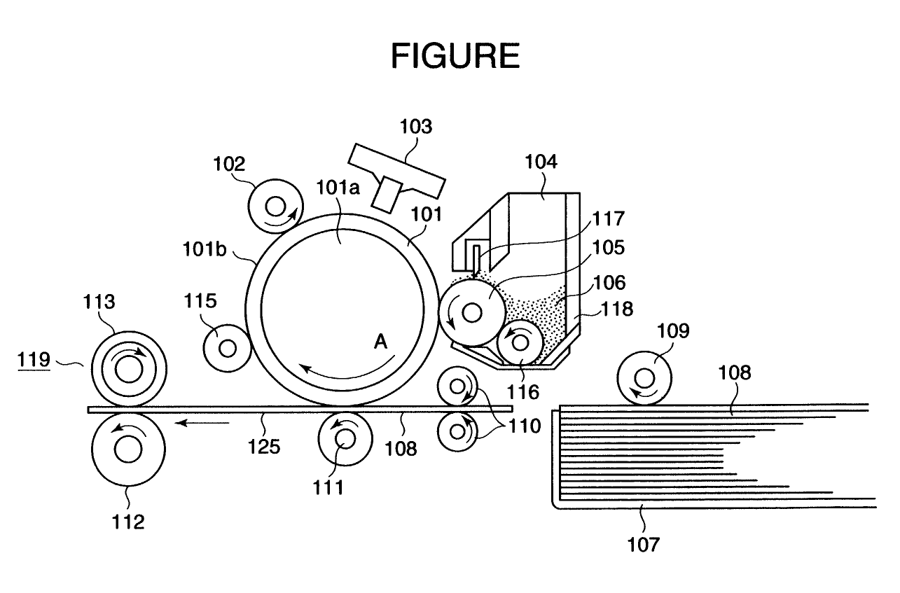

### BACKGROUND OF THE INVENTION

1. Field of the Invention

The present invention relates to a developing material for use in an electrophotographic recording apparatus such as electrophotographic printers and copying machines. The present invention also relates to a developing unit using the developer material.

2. Description of the Related Art

With conventional electrophotographic printers, an image is recorded by performing a series of steps of electrophotographic process in sequence, i.e., charging, exposing, developing, fixing, and cleaning. The charging device and transferring device use a corona charger that requires an expensive high-voltage power supply of about 5-10 kV. Corona chargers are susceptible to environmental changes, particularly humidity. That is, the charged potential of an electrostatic latent image bearing body varies with humidity. In addition, corona discharge causes ozone to be developed, the ozone deteriorating the characteristics of the electrostatic latent image as well as adversely affecting human body. In order to prevent harmful effect to the human body, the image-forming apparatus is provided with a filter that absorbs and breaks ozone to prevent ozone from being discharged outside of the image forming apparatus. However, the ozone filter has a short lifetime and requires frequent replacement.

In order to solve the aforementioned problem, a contact type charging device has been proposed. This charging device is constructed such that an electrically conductive charging roller having an electrical resistance value in the range of 10⁵-10⁶ □ is in contact with the electrostatic latent image bearing body and the charging roller receives a dc voltage to charge the electrostatic latent image bearing body.

A contact type transferring unit has been proposed. The transferring unit is constructed such that a transfer roller in the form of a semiconductive sponge roller abuts the electrostatic latent image bearing body with recording paper sandwiched between the transfer roller and the electrostatic latent image and the sponge roller receives a dc voltage to transfer a toner image onto the recording paper.

A commonly used developing unit is a dual-component developer magnetic brush type developing device in which a 3 to 10 wt. % of magnetic powder called “carrier” is mixed with a coloring material called “toner” and the mixture is supplied to the electrostatic latent image bearing body through a sleeve having a plurality of magnets. The developing unit requires toner-density detecting sensor that detects the weight percent (wt. %) of toner, a screw or paddle that mixes and stirs the carrier and toner. This leads to a complex, large-size, and expensive developing unit. The carrier deteriorates over a long period of time, requiring replacement of the carrier.

In order to solve the aforementioned drawbacks of the dual component magnetic brush type developing unit, a contact type developing unit has been proposed. The contact type developing unit is constructed such that an electrically conductive resilient developing roller having an electrical resistance value of less than 10⁶ Ω is in contact with the electrostatic latent image bearing body and the roller receives a dc voltage to develop the electrostatic latent image on the image bearing body into a toner image. Some of the dual component magnetic brush type developing units have a toner supplying roller that supplies toner stored in a tank to the developing roller.

An electric type cleaning device has been proposed. The electric type cleaning device is used together with a blade type cleaning device having a resilient blade in contact with the electrostatic latent image bearing body. Another developing unit have been proposed which reuses toner left on the electrostatic latent image bearing body in order to reduce the size and running cost of the cleaning device. This type of developing device has a screw or paddle that returns the residual toner from the cleaning unit to the developing unit.

The aforementioned charging roller, transfer roller, and cleaning roller need to contact with the electrostatic latent image bearing body and therefore, they must be made of a resilient material. The transfer roller and cleaning roller are made of a foamed rubber material and the charging roller and developing roller are made of a solid rubber material.

The toner-recycling type image-forming apparatus suffers from the problem that continuous recording at low duty cycle reduces recording density. Since toner is re-used, there is no chance of the residual toner of building up in the cleaning unit. Thus, reduction of recording density is considered to be due to the fact that the transferring roller, cleaning roller, and developing roller cause the toner to lose one of the powder characteristics, i.e., fluidity, and the toner having less fluidity returns to the developing unit. One of the major factors that cause fluidity to deteriorate is that low-molecular weight components (oligomer) material seeps from the roller material into toner, thereby causing the toner to clump.

In order to prevent toner from clumping, an image-forming apparatus has been proposed where the respective rollers are made of a rubber material that do not release oligomer therefrom, so that the toner is prevented from losing fluidity.

With an image forming apparatus that incorporates rollers made of a non-oligomer releasing material, a thin layer of toner is deposited on an area of the image bearing body in which the background portion of an printed image is printed. This apparatus also suffers from the problem referred to as “filming.” Filming is a phenomenon in which toner becomes caked on the image bearing body and the developing roller. “Filming” adversely affects the charging of the surface of the image bearing body.

### SUMMARY OF THE INVENTION

The present invention was made in view of the aforementioned problems.

A developing material is used for developing an electrostatic latent image in an electrophotographic process. The developing material includes a toner formed of a resin binder and a coloring material, and an oil added to surfaces of particles of the toner.

The oil may be silicone oil or fluorine oil. The oil is in the range of 0.01-3.0 wt. %.

A developing unit develops an electrostatic latent image with a toner in an electrophotographic process. The toner is formed of a resin binder and a coloring material. Silicone oil or fluorine oil is added to surfaces of particles of the toner.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

Figure illustrates an outline of a fixing device according to the present invention.

### DETAILED DESCRIPTION OF THE INVENTION

The present invention will be described in detail with reference to the accompanying drawings.

First Embodiment

{Construction}

Figure illustrates an outline of a fixing device according to the present invention.

Referring to Figure, an electrophotographic recording apparatus 100 incorporates an electrostatic latent image bearing body 101. Disposed around the image bearing body 101 are a charging unit 102, an exposing unit 103, a developing unit 104, a transferring unit 111, and a cleaning 115. The image bearing body 101 includes a drum-shaped conductive supporting member 101a and a photoconductive layer 101b formed on the conductive supporting member 101a. The developing unit 104 includes a developing roller 105, a toner supplying roller 116, a developing blade 117, and a hopper 118. The hopper 118 holds toner 106 therein. The developing blade 117 is in pressure contact with the developing roller 105 to form a thin layer of toner on the developing roller 105. The developing roller 105, toner supplying roller 116, and cleaning roller 115 are formed of urethane, which is a rubber material that do not release oligomer.

Transport rollers 110 and a fixing unit 119 are disposed along a transport path 125 through which recording paper 108 is advanced toward the image bearing body 101. The fixing unit 119 includes a heat roller 113 and a pressure roller 112. A paper cassette 107 holds a stack of the recording paper 108. A feed roller 109 is in pressure contact with the top page of a stack of the recording paper 108 accommodated in the paper cassette 107. Each time the feed roller 109 rotates, the top page of the recording paper 108 is fed from the paper cassette 107 into the transport path 125.

{Operation}

The operation of recording an image on the recording paper will be described.

The drum-shaped image bearing body 101 is driven in rotation by a drive means, not shown, at a predetermined speed in a direction shown by arrow A. The photoconductive layer 101b formed on the image bearing body 101 is in the form of an organic photoconductor. The photoconductive layer 101b may also be made of other material such as selenium photoconductor, zinc oxide photoconductor, or amorphous silicone photoconductor.

The charging unit 102 uniformly charges the surface of the image bearing body 101. Then, the exposing unit 103 illuminates the surface of the image bearing body 101 in accordance with print data, thereby forming an electrostatic latent image on the image bearing body 101. The exposing unit 103 may be, for example, a combination of a group of LED arrays and a SELFOC lens or a combination of a laser and an image-forming optical device.

The electrostatic latent image formed on the surface of the image bearing body 101 is developed with the toner 106 by the developing unit 104. The developing roller 105 is disposed such that the developing roller 105 is in intimate contact with the image bearing body 101, or with a very minute gap formed therebetween. The toner supplying roller 118 receives a high voltage from a high voltage source and rotates to supply the toner 106 to the developing roller 105. The developing roller 105 attracts the toner 106 and transports the toner 106 in a direction shown by an arrow. Then, the developing blade 117, which is disposed downstream with respect to the rotation of the developing roller 105, forms a toner layer of a uniform thickness.

A bias voltage is applied across the developing roller 105 and the conductive supporting member 101a of the image bearing body 101, so that an electric field is developed between the image bearing body 101 and the developing roller 105, the electric field being unique to an electrostatic latent image formed on the image bearing body 101. Thus, the toner 106 on the developing roller 105 is attracted to the image bearing body by the Coulomb force, thereby forming a toner image. The developing unit 104 according to the embodiment takes the form of a non-magnetic single component developing device.

The recording paper 108 accommodated in the paper cassette 107 is fed by the feed roller 109 into the paper transport path 125. The recording paper 108 first abuts the transport roller 110 which corrects skewed condition of the recording paper 108. Then, the transport roller 110 transports the recording paper 108 toward the image bearing body 101 in timed relation to the image formation on the image bearing body 101. The toner image on the image bearing body 101 is transferred by the transferring unit 111 onto the recording paper 108.

The recording paper 108 having the toner image thereon is further transported downstream of the transport path to the fixing unit 119 where the recording paper is pulled in between the heat roller 113 and the pressure roller 112. The heat roller 113 and pressure roller cooperate so that the toner on the recording paper 108 is heated to melt and penetrate into the recording paper 108. In this manner, the toner image is fixed. The discharge roller 116 discharges the recording paper 108 from the apparatus.

A small amount of toner is left on the surface of the image bearing body after the toner image has been transferred onto the recording paper 108. A high-voltage power supply applies a high voltage to the cleaning roller 115, so that the residual toner migrates from the image bearing body 101 to the cleaning roller 115. At a later timing, the residual toner on the cleaning roller 115 is allowed to migrate from the cleaning roller 115 to the image bearing body 101. Then, the image bearing body 101 rotates to transport the residual toner to the developing roller 105. The residual toner is collected from the developing roller 105 into the hopper 118.

{Toner}

The toner 106 will be described in detail.

The toner 106 used in the embodiment includes at least a resin binder and a coloring material. The coloring material has particles having an average diameter in the range of 3-15 μm and is mixed with an inorganic oxide having an average diameter in the range of 5-20 μm or an inorganic oxide having an average diameter in the range of 20 nm to 2 μm or a mixture of these two types of inorganic oxide. The toner 106 also includes silicone oil in the range of 0.01-3.0 wt. %. The resin binder helps the toner stick to the recording paper 108. The inventors made experiments for different amounts of silicone oil added to the surfaces of resin-based toner particles, thereby determining whether “filming” occurs on the image bearing body and developing roller after continuous recording and whether the toner loses fluidity after continuous recording.

The specific example of the toner 106 is a polymer toner having an average diameter of 7.5 μm, the toner including: stylene acrylic as a resin binder, carbon black as a coloring material, and 1.0 wt. % of 12 nm-silica added to the toner particles. The 12-nm silica serves as an inorganic oxide that has been subjected to hydrophobic treatment. Non-denatured dimethyl silicone oil was used as slicone oil.

For different amounts of silicone oil added to the toner particles, continuous printing was performed to record 10,000 pages to determine whether the printing results reflect the filming and the reduction of fluidity of toner. The continuous printing was performed for the following amounts of silicone oil added to the toner, i.e., 0 wt. %, 0.005 wt. %, 0.01 wt. %, 0.1 wt. %, 1.0 wt. %, 3.0 wt. %, and 3.5 wt. %.

Table 1 lists the results.

TABLE 1

| added amount of methyl | | | | | | | |
|---|---|---|---|---|---|---|---|
| silicone oil (wt. %) | 0 | 0.005 | 0.01 | 0.1 | 1 | 3 | 3.5 |
| filming (on the drum) | X | X | ◯ | ◯ | ◯ | ◯ | ◯ |
| filming (on the roller) | X | X | ◯ | ◯ | ◯ | ◯ | ◯ |
| early fluidity of toner | ◯ | ◯ | ◯ | ◯ | ◯ | ◯ | X |

Table 1 shows that addition of silicone oil less than 0.01 wt. % is not enough to prevent the filming. The table 1 also shows that adding silicone oil more than 3.0 wt. % causes lower fluidity that results in a decreased recording density for early pages of 10,000 pages. In other words, Table 1 shows that adding silicone oil in the range of 0.01-3.0 wt. % can prevent the filming on the surfaces of image bearing body and developing roller even when the roller material is prone to develop the filming. This implies that the roller material can be selected from a variety of materials.

The inventors performed similar experiments using other types of silicone oils. The following silicone oils showed similar results to methyl silicone: methyl hydrogen silicone oil, methyl phenyl silicone oil, amino denatured silicone oil, epoxy denatured silicone oil, carboxy denatured silicone oil, polyether denatured silicone oil, methacrylate silicone oil, mercapto-silicone oil, hydrophilic special denatured silicone oil, methacrylic denatured silicone oil, higher alkoxy denatured oil, and alkyl denatured silicone oil.

The inventors performed similar experiments using fluorine oil instead of silicone oil. Continuous recording was performed to record 10,000 pages, thereby determining whether filming occurs, a thin layer of toner is deposited on the background portion of a printed image, or the toner loses initial fluidity. The fluorine oil used has the following chemical formula.

TABLE 2

| added amount of | | | | | | | |
|---|---|---|---|---|---|---|---|
| fluorine oil (wt. %) | 0 | 0.005 | 0.01 | 0.1 | 1 | 3 | 3.5 |
| filming (on the drum) | X | X | ◯ | ◯ | ◯ | ◯ | ◯ |
| filming (on the roller) | X | X | ◯ | ◯ | ◯ | ◯ | ◯ |
| deposition of toner layer | X | X | ◯ | ◯ | ◯ | ◯ | ◯ |
| on the paper after | | | | | | | |
| continuous printing | | | | | | | |
| early fluidity of toner | ◯ | ◯ | ◯ | ◯ | ◯ | ◯ | X |

Table 2 shows that the addition of fluorine oil less than 0.01 wt. % is not enough to prevent the filming and a thin layer of toner is prone to be deposited on the image bearing body. The table 2 also shows that the addition of fluorine oil more than 3.0 wt. % can prevent the filming and the formation of thin layer of toner on the image bearing body 101 but causes the initial fluidity of toner to decrease. The decrease in initial fluidity results in insufficient recording density for early pages of printed 10,000 pages. In other words, Table 2 shows that adding fluorine oil in the range of 0.01-3.0 wt. % can prevent the filming on the surfaces of image bearing body and developing roller even when a roller material is prone to develop “filming”. This implies that the rollers material can be selected from a variety of materials. Further, a thin layer of toner can be prevented from being formed on the image bearing body 101, so that printing quality after continuous printing is improved.

The inventors further performed experiments using fluorine denatured silicone oil or carbinol denatured silicone oil that is added to the surfaces of toner particles. Continuous recording was performed to record 10,000 pages to determine whether the filming occurs, a thin layer of toner is deposited on an area of the image bearing body 101 in which the background portion of a printed image is recorded, or the toner loses initial fluidity. Table 3 shows the test results when fluorine denatured silicone oil is used.

TABLE 3

| added amount of fluorine | | | | | | | |
|---|---|---|---|---|---|---|---|
| denatured oil (wt. %) | 0 | 0.005 | 0.01 | 0.1 | 1 | 3 | 3.5 |
| filming (on the drum) | X | X | ◯ | ◯ | ◯ | ◯ | ◯ |
| filming (on the roller) | X | X | ◯ | ◯ | ◯ | ◯ | ◯ |
| deposition of thin toner | X | X | ◯ | ◯ | ◯ | ◯ | ◯ |
| layer after continuous | | | | | | | |
| printing | | | | | | | |
| early fluidity of toner | ◯ | ◯ | ◯ | ◯ | ◯ | ◯ | ◯ |
| fluidity of toner after | ◯ | ◯ | ◯ | ◯ | ◯ | ◯ | X |
| continuous printing | | | | | | | |

Table 3 shows that the addition of fluorine denatured silicone oil of less than 0.01 wt. % is not enough to prevent the filming and cannot prevent a thin layer of toner from increasing after continuous recording. The table 3 also shows that the addition of fluorine denatured silicone oil of more than 3.0 wt. % can prevent the filming and the formation of thin layer of toner on the image bearing body but causes the initial fluidity of toner to decrease resulting in insufficient recording density after continuous recording. The inventors performed similar experiments using other type of silicone oil, i.e., carbinol denatured silicone oil and obtained similar results to those in Table 3.

Table 3 shows that adding fluorine denatured silicone oil or carbinol denatured silicone oil in the range of 0.01-3.0 wt. % can prevent the filming from developing even when the roller material is prone to develop the filming on the image bearing body and developing roller. This implies that the roller material can be selected from a variety of materials. Further, the present invention can prevent the formation of a thin layer of toner on the image bearing body during continuous printing as well as the decrease in recording density, improving the recording quality in continuous recording.

In the aforementioned experiments, the toner 106 was a polymer toner having stylene acrylic as a resin binder. Other resin binders may be used. Crushed toner may also be used.

Regardless of whether the developing method is the dual-component developing method or the magnetic single-component developing method, the oil protects the toner particles and provides the same advantages.

In the aforementioned experiments, the material for the developing roller 105, the toner supplying roller 116 and the cleaning roller 115 is urethane rubber that does not release oligomer. The material may also be, for example, stylene-buthadiene copolymer rubber, acrylonitrile-butadiene copolymer rubber, acrylic rubber, epichlorohydrin rubber, silicone rubber, EPDM (ethylene-propylene rubber), or NBR (nitrile rubber), or a combination of two or more of these rubber materials.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A developing material for developing an electrostatic latent image in an electrophotographic process, the developing material comprising;
a toner formed of a resin binder and a coloring material; and
an oil added to surfaces of particles of the toner.

2. The developing material according to claim 1, wherein said oil is silicone oil.

3. The developing material according to claim 1, wherein said oil is fluorine oil.

4. The developing material according to claim 2, wherein said oil is in the range of 0.01-3.0 wt. %.

5. A developing unit that develops an electrostatic latent image with a toner in an electrophotographic process, wherein the toner is formed of a resin binder and a coloring material, and an oil is added to surfaces of particles of the toner, the oil being silicone oil or fluorine oil.
